(19) United States
(12) Patent Application Publication
(10) Pub. No.: US 2010/0058479 A1
(43) Pub. Date: Mar. 4, 2010

(54) Method and system for combating malware with keystroke logging functionality

(75) Inventors: Shu-Lin Chen, Kanata (CA); Stanley Chow, Ottawa (CA); Christophe Gustave, Ottawa (CA)

Correspondence Address: ALCATEL-LUCENT, C/O GALASSO & ASSOCIATES, LP, P. O. BOX 26503, AUSTIN, TX, 78755-0503, US

(73) Assignee: ALCATEL-LUCENT

(21) Appl. No.: 12/231,435

(22) Filed: Sep. 3, 2008

(51) Int. Cl. G06F 21/00

(52) U.S. Cl. 726/26

(57) ABSTRACT

A method is carried out by a computer system for combating malicious keystroke-logging activities thereon. An operation is performed for generating a plurality of fake keystroke datasets that are each configured to resemble a keystroke dataset generated by keystrokes made on an input device of the computer system while entering sensitive information of a prescribed configuration. An operation is performed for receiving an instance of the sensitive information instance of the prescribed configuration concurrently with generating the fake keystroke datasets. Receiving the sensitive information instance includes a user of the computer system entering the sensitive information instance by performing keystrokes on the input device of the computer system such that a real keystroke dataset corresponding to the sensitive information instance is generated. An operation is performed for embedding the real keystroke dataset within at least a portion of the fake keystroke datasets after receiving the sensitive information instance.

### FIELD OF THE DISCLOSURE

The disclosures made herein relate generally to systems and methods for combating malware and, more particularly, methods and systems for combating malware with keystroke logging functionality.

### BACKGROUND

Keystroke logging on a computer system refers to a method of capturing and recording computer user keystrokes. It can be used to steal confidential information such as, for example, account numbers and passwords. Malware, which is malicious code designed to provide unauthorized access to information on a computer system, can and often does have keystroke logger incorporated therewith for the purpose of stealing such confidential information so that it can be provided to an unscrupulous party associated with the malware. As can be seen, keystroke-logging malware residing on a computer system is highly undesirable.

There are two prevalent approaches for integrating keystroke-logging functionality into a computer system. The first approach includes low-level keyboard reading, which reads key codes directly from keys pressed on a keyboard of the computer system. The second approach includes using an “OS message” that tell an application something has been typed.

Keystroke logging functionality can be hardware-based or software-based. Hardware-based keystroke logging equipment can be difficult to install because installation requires physical access to a computer system on which it is to be installed. Such access is typically needed for both installation of the keystroke logging hardware and retrieval of the keystroke logging hardware. In contrast, contrast, software-based keystroke logging can be remotely installed and monitored, its operation is difficult to detect using conventional detection approaches, and free keystroke logging codes (i.e., freeware) is readily available for download. As such, malware that captures keystroke information generally uses software-based keystroke logging as opposed to hardware-based keystroke logging.

One conventional approach for combating keystroke-logging malware (i.e., malicious keystroke logging activity) includes detecting the existence of unauthorized keystroke logging functionality. Such unauthorized detection can be implemented in a manual and/or signature-based manner, but neither implementation has been found to works well in practice. Manual detection includes a user monitoring either application processes or network traffic on local host. This manual approach is not practical because it requires users to be constantly checking the system for abnormal behavior, which is an unbearable burden on a user and, most of the time, users are not qualified to decide whether a specific process or network traffic is suspicious. Signature-based detection is performed by an anti-spyware application that relies on authenticatable signatures. Shortcomings of signature-based detection is that only known malware can be detected, signatures must be constantly updated, confidential information could have been stolen by the time signature is ready and having to pay an annual subscription cost to have the up-to-date signatures. Thus, while detection techniques can detect certain key loggers, they don't make key loggers easier to detect.

Another approach for combating keystroke-logging malware includes not letting the keystroke logger see keystrokes (i.e., evasion techniques). These approaches for combating keystroke-logging malware emphasize different ways to input confidential information in a manner that reduces the chance that keystroke logging malware can capture such confidential information. Furthermore, these approaches tend to be difficult to use, only works against “low level” keystroke logging code, and typically fail against keystroke logging malware that utilizes operating system (OS) messages. One technique for combating keystroke logging malware by not letting the keystroke logger see keystrokes includes fooling the malware by alternating between typing confidential information and typing characters somewhere else in the focus. Similarly, one can move their cursor using the mouse during typing, causing the logged keystrokes to be in the wrong order. Another very similar technique utilizes the fact that any selected text portion is replaced by the next key typed. For example, if the password is “secret”, one could type “s”, then some dummy keys (e.g., asdfsd). Then, the dummy keys could be (e.g., asdfsd). Then, the dummy keys could be selected with the mouse, and next character from the password “e” is typed, which replaces the dummy keys “asdfsd”. Another technique for combating keystroke logging malware by not letting the keystroke logger see keystrokes uses form fillers that are primarily designed for web browsers to fill in form pages and log users into their accounts. Once the user's account and credit card information has been entered once into the program, it will be cached and automatically entered into forms without using the keyboard therefore reducing the possibility that private data is being recorded. However, this approach does not prevent a key logger to record the manual filling in the first place. In addition, this generally cannot protect non-web based applications. Still another technique for combating keystroke-logging malware by not letting the keystroke logger see keystrokes includes using a non-standard input device or user interface for entering confidential information. Instead of using a standard keyboard, alternative means such as customized keyboard, on-screen keyboards, speech recognition and handwriting/mouse gesture are used. However such alternative means all suffer from different problems. Customized keyboards or on-screen keyboards do not combat against keystroke loggers, logging the use of OS messaging to do the key code to character translation or to capture application-level messages. For speech recognition and handwriting/mouse gesture, special software or hardware such as touch screen is required, which are not common pieces of equipment in most computer systems. Also, in general, evasion techniques cannot detect presence of keystroke logging functionality or make it easier to detect.

Using One-Time Password (OTP) such as, for example, a smart card is keylogger-safe because the user's credentials are always invalidated right after they are used. Thus, OTP is an effective approach for combating keystroke logging malware. Unfortunately, however, deploying OPT techologies are generally very costly and impractical because each application or websites must be modified. Such modifications cannot be done uniletaraly at the client side. Moreover, this is very specific and limited to preventing fraudulent access to legitimate user application sessions.

As can be seen from the foregoing discussion, various approaches are known for attempting to combat keystroke-logging malware. However, such conventional approaches exhibit one or more shortcomings that limit their effectiveness and/or practicality. Also these approaches don't make it easier for keystroke-logging malwares to be detected. Therefore, an approach for combat malware that that carries out keystroke logging that overcomes shortcomings associated with such conventional approaches would be advantageous, desirable and useful.

### SUMMARY OF THE DISCLOSURE

Embodiments of the present invention provide for a simple technique of combating malware with keystroke logging functionality. More specifically, embodiments of the present invention are configured to automatically generate (e.g., via simulated typing function) large quantities of fake keystroke datasets that resemble real keystroke datasets corresponding to sensitive information such as credit card numbers, login accounts and the like and combine such fake keystroke datasets with one or more real keystroke datasets corresponding sensitive information manually key stroked by a user. A malicious party coming into possession of such combined keystroke datasets would have to invest a considerable amount of time and resources to try identifying which portion of the combined keystroke datasets is real/useful. Compared to conventional solutions for combating malware with keystroke logging functionality, combating malware with keystroke logging functionality using solutions configured in accordance with embodiments of the present invention are easy to implement, protect information but also make keystroke-logging malware easier to detect, and do not rely on signature authentication so that newly-created malware can be readily detected.

The benefits of such an approach to combating malware with keystroke logging functionality are numerous. One benefit is that, by luring keystroke-logging malware into collecting and sending out large amounts of known fake keystroke datasets, it is easier to detect the presence of such keystroke-logging malware by a personal firewall, a network-based intrusion detection system, a data exfiltration system, a data-leak prevention systems and the like. Another benefit is that keystroke-logging malware will likely consume much more CPU/memory usage or network traffic, making it more likely to be noticed by the user, software add-ons that can automatically take actions, and the like. Still further, another benefit is that real confidential information is protected by making it harder to identify. In this manner, a malware perpetrator cannot just sell the collected data because most of it is fake and, thus, worthless. As far as a malware perpetrator would be concerned, the value of the real information has been essentially destroyed.

In one embodiment of the present invention, a method carried out by a computer system for combating malicious keystroke-logging activities thereon. The method includes a plurality of operations. An operation is performed for generating a plurality of fake keystroke datasets that are each configured to resemble a keystroke dataset generated by keystrokes made on an input device of the computer system while entering sensitive information of a prescribed configuration. An operation is performed for receiving an instance of the sensitive information instance of the prescribed configuration concurrently with generating the fake keystroke datasets. Receiving the sensitive information instance includes a user of the computer system entering the sensitive information instance by performing keystrokes on the input device of the computer system such that a real keystroke dataset corresponding to the sensitive information instance is generated. An operation is performed for embedding the real keystroke dataset within at least a portion of the fake keystroke datasets after receiving the sensitive information instance.

In another embodiment of the present invention, an apparatus having data processor-readable instructions thereon and being accessible therefrom. Instructions are provided for generating a plurality of fake keystroke datasets that are each configured to resemble a keystroke dataset generated by keystrokes made on an input device of the computer system while entering sensitive information of a prescribed configuration. Instructions are provided for receiving an instance of the sensitive information instance of the prescribed configuration concurrently with generating the fake keystroke datasets. Receiving the sensitive information instance includes a user of the computer system entering the sensitive information instance by performing keystrokes on the input device of the computer system such that real keystroke dataset corresponding to the sensitive information instance is generated. Instructions are provided for embedding the real keystroke dataset within at least a portion of the fake keystroke datasets, wherein the generating of fake keystroke datasets continues during embedding of the real keystroke data.

In another embodiment of the present invention, a computer system comprises a keystroke dataset generator, an input device, a dataset embedder, and a keystroke dataset consumer. The keystroke dataset generator is configured for generating a plurality of fake keystroke datasets that are each configured to resemble a keystroke dataset generated by keystrokes made on an input device of the computer system while entering sensitive information of a prescribed configuration. The input device is configured for allowing information to be manually entered by keystrokes being manually performed thereon. The dataset embedder is configured for embedding the real keystroke dataset within at least a portion of the fake keystroke datasets. The keystroke dataset consumer is configured for having the keystroke datasets generated on the computer system provided thereto.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 shows a method configured in accordance with an embodiment of the present invention for spoofing software-based keystroke logging functionality.

FIG. 2 shows a computer system configured in accordance with an embodiment of the present invention for spoofing software-based keystroke logging functionality.

FIG. 3 shows a specific embodiment of an obfuscation process configured in accordance with an embodiment of the present invention for protecting a particular format of an ID/password combination against software-based keystroke logging.

### DETAILED DESCRIPTION OF THE DRAWING FIGURES

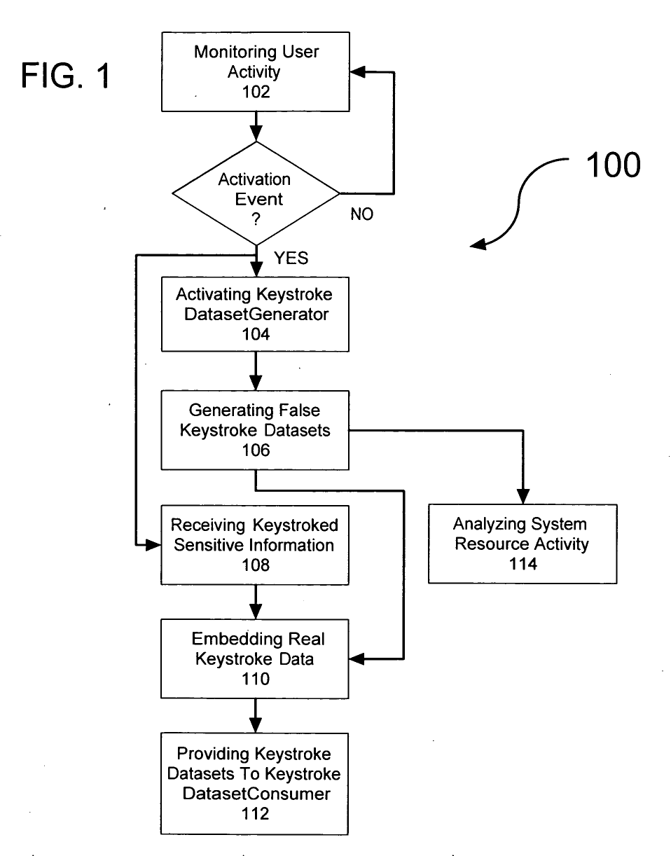

FIG. 1 shows a method 100 for combating malicious keystroke-logging activities in accordance with an embodiment of the present invention. The method 100 combats malware with keystroke logging functionality by automatically generating large quantities of fake keystroke datasets that resemble real keystroke data sets corresponding to sensitive information such as credit card numbers, login accounts and the like and by combining at least a portion of such fake keystroke datasets with one of more real keystroke datasets. A malicious party coming into possession of such combined keystroke dataset information will have to expend a timely and difficult task of identifying which portion of the combined keystroke datasets is real. Compared to conventional solutions for combating malware with keystroke logging functionality, combating malware with keystroke logging functionality using a method configured in accordance with the present invention is easy to implement, protects information while also make keystroke-logging malware easier to detect, and does not rely on signature authentication so that newly-created malware can be readily detected.

The method 100 begins with an operation 102 for monitoring user activity for determining if spoofing of keystroke logging functionality (i.e., for spoofing keystroke logging malware) needs to be activated. If it is determined that the user activity does not require such spoofing of keystroke logging functionality, the method continues such monitoring. If it is determined that the user activity does require such spoofing of keystroke logging functionality, the method continues at an operation 104 for activating a keystroke dataset generator. Dataset as used herein with respect to keystokes refers to computer-interpretable information defining a particular set of keystrokes (i.e., the logical/electronic information that is generated in response to a key on a keyboard being pressed). Examples of user activity that require activation of such spoofing of keystroke logging functionality include, but are not limited to, data being entered into a prescribed type of data field (e.g., a credit card field, social security number field or the like), a prescribed type of application being started (e.g., an application that collects/manages personal information), a prescribed application being started and a secure network connection being initiated.

In response to activating the keystroke dataset generator, an operation 106 is performed for generating fake keystroke datasets concurrently with an operation 108 being performed for receiving sensitive information, which is received by a user keystroking such information via a keyed input device (e.g., a keyboard of a computer). Generating the fake keystroke datasets includes determining a configuration of keystroke datasets corresponding to real sensitive information to be received (i.e., in response to being manually keystroked on a keyboard) or being entered, and generating the fake keystroke datasets in accordance with such keystroke dataset configuration. For example, in the case where it is determined that credit card information is being entered, the fake keystroke datasets are configured to resemble the configuration of a keystroke dataset generated when such credit card information is entered (i.e., manually keystroked).

In one embodiment, generating the fake keystroke datasets includes generating the fake keystroke datasets in a manner whereby the fake keystroke datasets correspond to prescribed information thereby allowing the fake keystroke datasets to be tracked. This can be accomplished by configuring the fake keystroke dataset to correspond to information related to a particular person, a particular entity or institution, a particular investigation code or the like. In another embodiment, generating the fake keystroke datasets includes generating the fake keystroke datasets in a non-trackable manner whereby the fake keystroke datasets do not correspond to any associated information.

After receiving the keystroked sensitive information, an operation 110 is performed for embedding the real keystroke dataset corresponding to such sensitive information within all or a portion of the fake keystroke datasets that has been generated. Embedding the real keystroke dataset within the fake keystroke datasets can be done in a logical buffer, a database or spreadsheet, or the like. The present invention is not unnecessarily limited to a particular manner in which the real keystroke dataset is embedded within the fake keystroke datasets. The objective of such embedding is to create a collection of keystroke datasets that have the same configuration (e.g., keystroked credit card information) such that the real keystroke dataset is hidden among a plurality of fake keystroke datasets. In one embodiment, the operation of generating of fake keystroke datasets is performed prior to, during and after the real keystroke dataset is embedded with the fake keystroke datasets. In another embodiment, the operation of generating of fake keystroke datasets is performed prior to and after after such embedding whereby the real and fake keystroke datasets are concurrently generated in a seamless manner as a string of keystroke datasets. In conjunction with or after embedding the real keystroke dataset with the fake keystroke datasets, an operation 112 is performed for providing (e.g., outputting) the keystroke datasets to a keystroke data set consumer. The consumer module serves as a recipient of the keystroke datasets.

In conjunction with generating the fake keystroke datasets, an operation 114 for analyzing system resource activity can be performed for the purpose of determining the potential presence of keystoke logging activity malware. For example, system resource activity related to transmission of the fake keystroke datasets can be analyzed for detecting the actual transmission of the fake keystroke datasets, the potential transmission of the fake keystroke datasets (i.e., suspicious activity) or the like. Because the keystroke dataset generator continuously generates fake keystroke datasets over an extended period of time, it could be expected that keystroke logging malware would be busy collecting and sending such fake keystroke datasets. By looking at the memory and/or processor usage and/or monitoring outgoing traffic volume (i.e., system resource activity), analysis of such system resource activity can provide conclusive or potential indication of the existence of keystroke logging malware so that appropriate further actions can be taken to terminate such malicious keystroke logging activity.

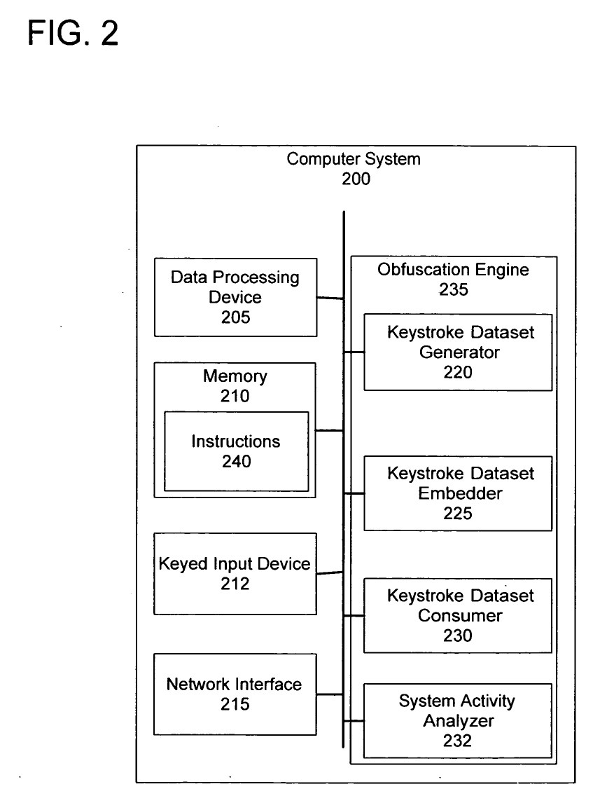

Referring now to FIG. 2, a computer system 200, configured in accordance with an embodiment of the present invention is shown. As will be discussed in greater detail below, the computer system 200 is configured in accordance with the present invention for combating malicious keystroke logging activities. For example, the computer system 200 is suitably configured for implementing the method 100 discussed above in reference to FIG. 1.

The computer system access node 200 includes a data processing device 205, memory 210, a keyed input device 212, a network interface 215, a keystroke dataset generator 220, a dataset embedder 225, a keystroke dataset consumer 230 and a system activity analyzer 232. The data processing device 205, the memory 210, the network interface 215, the keystroke dataset generator 220, the dataset embedder 225, the keystroke dataset consumer 230 and the system activity analyzer 232 are interconnected for enabling interaction therebetween. Jointly, the keystroke dataset generator generator 220, the dataset embedder 225, the keystroke dataset consumer 230 and the a system activity analyzer 232 are an embodiment of an obfuscation engine 235 configured in accordance with the present invention for combating malicious keystroke logging activities.

The keystroke dataset generator 220 is configured for generating a plurality of fake keystroke datasets that are each configured to resemble a keystroke dataset generated by keystrokes made on an input device of the computer system while entering sensitive information of a prescribed configuration. The input device 212 is configured for allowing information to be manually entered by keystrokes being manually performed thereon. The dataset embedder 225 is configured for embedding the real keystroke dataset within at least a portion of the fake keystroke datasets. The keystroke dataset consumer 230 is configured for having the keystroke datasets generated on the computer system provided thereto. The system activity analyzer 232 is configured for analyzing system resource activity related to transmission of the fake keystroke datasets and for identifying at least one actual transmission of the fake keystroke datasets and potential transmission of the fake keystroke datasets in response to performing the analyzing.

In one embodiment, the keystroke dataset generator 220, the dataset embedder 225 and the keystroke dataset consumer 230 can be logic functionality components that provide respective functionality in view of instructions 240 residing in the memory 210, which are accessed, interpreted and implemented by the data processing device 205. More specifically, the instructions 240 are configured for causing the keystroke dataset generator 220, the dataset embedder 225 and the keystroke dataset consumer 230 to combating malicious keystroke logging activities in accordance with the present invention. The instructions 240 are accessible from within the memory 210 and are processable by the data processing device 205. Broadly, the instructions 230 are configured for enabling the data processing device 205 to facilitate the operations of generating a plurality of fake keystroke datasets that are each configured to resemble a keystroke dataset generated by keystrokes made on a keyed input device of the computer system (e.g.; a keyboard) while entering sensitive information of a prescribed configuration, receiving an instance of the sensitive information instance of the prescribed configuration concurrently with generating the fake keystroke datasets, whereby such receiving the sensitive information instance includes a user of the computer system entering the sensitive information instance by performing keystrokes on the input device of the computer system such that a real keystroke dataset corresponding to the sensitive information instance is generated, and embedding the real keystroke dataset within at least a portion of the fake keystroke datasets after receiving the sensitive information instance.

The obfuscation engine 235 can be configured to start up automatically when the computer 200 is booted. The keystroke dataset generator 220 can be configured to be activated in either an automatic manner and/or manual manner. Preferably, the keystroke dataset generator 220 is active whenever information being typed is deemed to be sensitive or otherwise worth protecting against keystroke logging. For example, this could depend on the application or a specific text field a user is going to fill. Alternatively, there can be an activation control (e.g., function key of the keyboard or on-screen selector) that allows selective activation of the keystroke dataset generator 220. With the keystroke dataset generator 220 is active and when a user begins typing sensitive information, the keystroke dataset (i.e., keystrokes) corresponding to entry of such sensitive information will be mixed (i.e., embedded) with the fake keystroke datasets generated by the keystroke dataset generator 220. A malicious party that accesses information gathered by the keystroke logging malware will need to go through a long list of keystroke datasets to find out which one of such datasets could be a real keystroke dataset. Such a task would prove to be an expensive and challenging proposition because typically, a real keystroke dataset could be mixed with hundreds or thousands of fake keystroke datasets.

Preferably, but not necessarily, the keystroke dataset generator 220 and the keystroke dataset consumer 230 use common logic and/or /communication channels that keystroke logging malware “hooks” into so that the keystroke logging malware will see the fake keystrokes being generated by the keystroke dataset generator 220. The two most common methods used to implement software-based keystroke logging are: 1.) a system hook to intercept notification of a key is pressed and 2.) a cyclical information keyboard request from the keyboard using APIs such as GetKeyState or GetKeyBoardState. Keystroke logging that is based on such a ‘hook’ are often found to use Microsoft Windows function SetWindowsHookEx( ) to set up a hook and monitors messages for key pressed. A typical example of such a hook-based keystroke logger, which has been found hidden in many Trojans on the Internet, is known under the name “Blazing Tools Perfect Keylogger”. For a keystroke logger of this type, an API SendInput( ) can be used to create messages such as WM_SYSKEYDOWN and WM_SYSKEYDOWN and WM_KEYDOWN to simulate a key pressed and allow them to be captured by the keystroke logger. For keystroke loggers that use APIs such GetKeyState or GetKeyBoardState, sample code are available on the MSDN (Microsoft Development Network). For them, we can use SetKeyBoardState to simulate pressed keys. A skilled person will appreciate the above approaches for simulating the pressing of keys of a keyboard can be combined into a single keystroke logger bait program and can be configured to “send out” keystroke datasets using different techniques so that, no matter how a particular keystroke logger acquired keystroke datasets, it will be “lured” to catch the bait (i.e., false) keystroke datasets generated by the keystroke dataset generator 220.

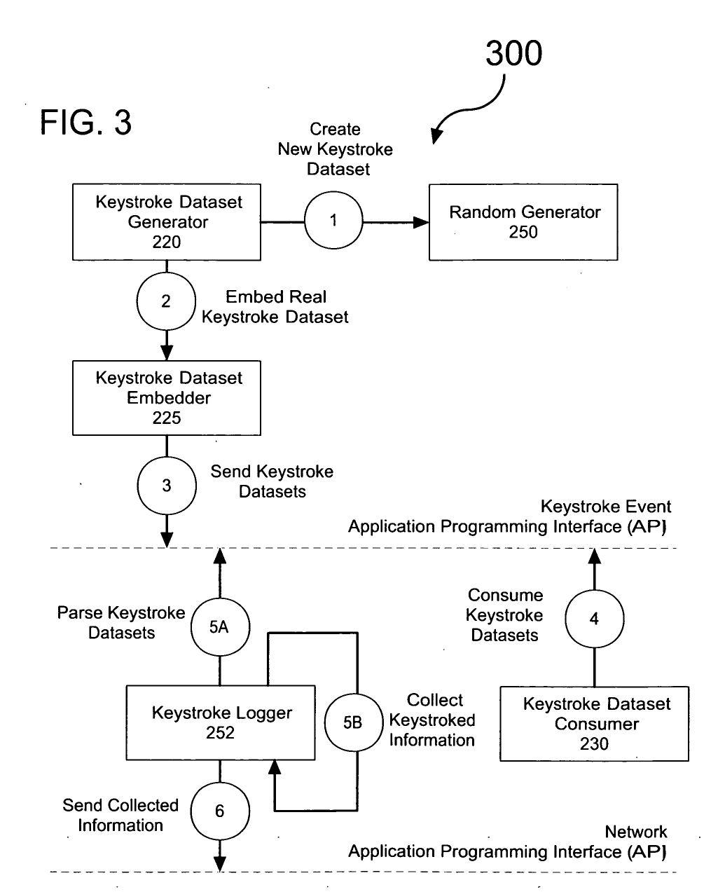

FIG. 3 shows an obfuscation process 300 configured in accordance with an embodiment of the present invention for protecting a particular format of an ID/password combination (i.e., sensitive information). While the process is described in view of the obfuscation engine 235 of FIG. 2, it is disclosed herein and a skilled person will appreciate that the obfuscation process 300 is not limited to being implemented via the obfuscation engine 235 of FIG. 2, but can be implemented via other embodiments of the present invention. In combination with a random generator 250, the keystroke dataset generator 220 generates (i.e., creates) randomized faked ID/password combinations. In combination with a user keying in sensitive information and the keystroke dataset generator 220 generating the fake keystroke datasets configured to resemble the format of the ID/password combination, the keystroke dataset embedder 225 embeds the real keystroke dataset within at least a portion of the fake keystroke datasets. The keystroke datasets are sent to the keystroke dataset consumer 230 for final consumption. A keystroke logger 252 will parse the keystroke datasets, collect such keystroke datasets and send the keystroke datasets for receipt by equipment of a party having access to/knowledge of the keystroke logger 252.

Referring now to instructions processable by a data processing device, it will be understood from the disclosures made herein that methods, processes and/or operations adapted for carrying out functionality for spoofing software-based keystroke logging as disclosed herein are tangibly embodied by computer readable medium having instructions thereon that are configured for carrying out such functionality. In one specific embodiment, the instructions are tangibly embodied for carrying out the method 100 disclosed above. The instructions may be accessible by one or more data processing data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out functionality for spoofing software-based keystroke logging in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method carried out by a computer system for combating malicious keystroke-logging activities thereon, comprising:
generating a plurality of fake keystroke datasets that are each configured to resemble a keystroke dataset generated by keystrokes made on an input device of the computer system while entering sensitive information of a prescribed configuration;
receiving an instance of said sensitive information instance of the prescribed configuration concurrently with generating said fake keystroke datasets, wherein receiving said sensitive information instance includes a user of the computer system entering said sensitive information instance by performing keystrokes on the input device of the computer system such that a real keystroke dataset corresponding to said sensitive information instance is generated; and
embedding the real keystroke dataset within at least a portion of said fake keystroke datasets.

2. The method of claim 1 wherein said generating of fake keystroke datasets is performed prior to, during and after said embedding.

3. The method of claim 2 wherein generating said fake keystroke datasets includes generating said fake keystroke datasets in a manner whereby said fake keystroke datasets correspond to prescribed information thereby allowing said fake keystroke datasets to be tracked.

4. The method of claim 1 wherein generating said fake keystroke datasets is initiated in response to at least one of data being entered into a prescribed type of data field, a prescribed type of application being started, a prescribed application being started and a secure network connection being initiated.

5. The method of claim 1 wherein generating said fake keystroke datasets includes generating said fake keystroke datasets in a random manner whereby said fake keystroke datasets do not correspond to any associated information.

6. The method of claim 1 wherein generating said fake keystroke datasets includes generating said fake keystroke datasets in a manner whereby said fake keystroke datasets correspond to prescribed information thereby allowing said fake keystroke datasets to be tracked.

7. The method of claim 6, further comprising:
analyzing system resource activity related to transmission of said fake keystroke datasets for detecting at least one of actual transmission of said fake keystroke datasets and potential transmission of said fake keystroke datasets.

8. The method of claim 1, further comprising:
analyzing system resource activity related to transmission of said fake keystroke datasets for detecting at least one of actual transmission of said fake keystroke datasets and potential transmission of said fake keystroke datasets.

9. An apparatus having data processor-readable instructions thereon and being accessible therefrom, said instructions including:
instructions for generating a plurality of fake keystroke datasets that are each configured to resemble a keystroke dataset generated by keystrokes made on an input device of the computer system while entering sensitive information of a prescribed configuration;
instructions for receiving an instance of said sensitive information instance of the prescribed configuration concurrently with generating said fake keystroke datasets, wherein receiving said sensitive information instance includes a user of the computer system entering said sensitive information instance by performing keystrokes on the input device of the computer system such that real keystroke dataset corresponding to said sensitive information instance is generated; and
instructions for embedding said real keystroke dataset within at least a portion of said fake keystroke datasets, wherein said generating of fake keystroke datasets continues during embedding of said real keystroke data.

10. The apparatus of claim 9 wherein said generating of fake keystroke datasets is performed prior to, during and after said embedding.

11. The apparatus of claim 10 wherein generating said fake keystroke datasets includes generating said fake keystroke datasets in a manner whereby said fake keystroke datasets correspond to prescribed information thereby allowing said fake keystroke datasets to be tracked.

12. The apparatus of claim 9 wherein generating said fake keystroke datasets is initiated in response to at least one of data being entered into a prescribed type of data field, a prescribed type of application being started, a prescribed application being started and a secure network connection being initiated.

13. The apparatus of claim 9 wherein generating said fake keystroke datasets includes generating said fake keystroke datasets in a random manner whereby said fake keystroke datasets do not correspond to any associated information.

14. The apparatus of claim 9 wherein generating said fake keystroke datasets includes generating said fake keystroke datasets in a manner whereby said fake keystroke datasets correspond to prescribed information thereby allowing said fake keystroke datasets to be tracked.

15. The apparatus of claim 14, further comprising:
analyzing system resource activity related to transmission of said fake keystroke datasets for detecting at least one of actual transmission of said fake keystroke datasets and potential transmission of said fake keystroke datasets.

16. The apparatus of claim 9, further comprising:
analyzing system resource activity related to transmission of said fake keystroke datasets for detecting at least one of actual transmission of said fake keystroke datasets and potential transmission of said fake keystroke datasets.

17. A computer system, comprising:
a keystroke dataset generator configured for generating a plurality of fake keystroke datasets that are each configured to resemble a keystroke dataset generated by keystrokes made on an input device of the computer system while entering sensitive information of a prescribed configuration;
an input device configured for allowing information to be manually entered by keystrokes being manually performed thereon;
a dataset embedder configured for embedding said real keystroke dataset within at least a portion of said fake keystroke datasets; and
a keystroke dataset consumer configured for having said keystroke datasets generated on the computer system provided thereto.

18. The computer system of claim 17 wherein:
the keystroke dataset generator, the keystroke dataset consumer and the dataset embedder are modules of an obfuscation engine;
the obfuscation engine starts up upon booting of the computer system; and
said generating of fake keystroke datasets is performed prior to, during and after said embedding.

19. The computer system of claim 17, further comprising:
a system activity analyzer configured for analyzing system resource activity related to transmission of said fake keystroke datasets and for identifying at least one actual transmission of said fake keystroke datasets and potential transmission of said fake keystroke datasets in response to performing said analyzing.

20. The computer system of claim 17 wherein generating said fake keystroke datasets is initiated in response to at least one of data being entered into a prescribed type of data field, a prescribed type of application being started, a prescribed application being started and a secure network connection being initiated.
